(19) United States
(12) Patent Application Publication
(10) Pub. No.: US 2022/0219184 A1
(43) Pub. Date: Jul. 14, 2022

(54) Coating of Surfaces using the Drop-on-Demand Method

(71) Applicant: EPAINTERS LICENSING GMBH, Gundelfingen (DE)

(72) Inventor: Burkhard Büstgens, Gundelfingen (DE)

(73) Assignee: Epainters Licensing GmbH, Gundeldfingen (DE)

(21) Appl. No.: 17/615,113

(22) PCT Filed: May 29, 2020
(86) PCT No.: PCT/DE2020/000116

§ 371 Date: Nov. 30, 2021

(30) Foreign Application Priority Data
Jun. 3, 2019 (DE) 10 2019 003 844.4

(51) Int. Cl. B05B 12/12; B05D 1/26; B05D 5/00; B05B 1/14; B05B 1/30; B05B 15/50

(52) U.S. Cl. CPC B05B 12/126; B05D 1/26; B05B 15/50; B05B 1/14; B05B 1/306; B05D 5/005

(57) ABSTRACT

The invention relates to a method for coating an application surface (11) of a component (10), in particular of a building, within an application area (12) with a coating agent, in particular with a building paint, comprising a step of edge application to the application area (12) and a step of surface application to the application area (12), which does not include the edge application, characterised in that a first application method on the basis of the drop-on-demand method is used in the edge application step, and a second application method, which has a higher surface coating output than the first application method, is used in the surface application step.

The invention relates to the field of coating surfaces with coating agents (in particular paints and lacquers) of components, in particular of buildings, but also of vehicles, in particular motor vehicles, in particular of bodywork components.

In particular, the invention relates to the coating of the aforementioned surfaces with drop-on-demand (DOD) processes, or printing processes, with sharp edges, without dripping and without spraying, and focuses, on the one hand, on the precise and sharp-edged application of the edges and corners of an application area 12 and, on the other hand, on the coating of the surface areas of an application area 12 within the edge areas 12a, while at the same time beneficial aspects of conventional paint application techniques are to be taken into account.

When applying architectural paints—especially interior wall paints in commercially or privately used residential and office buildings, coating can usually be carried out with acceptable surface work rates, measured in square metres per minute [sqm/min] using paint rollers, brushes or paint spraying equipment, as long as large surface areas are to be coated. However, there is the problem that, for example, when coating wall surfaces in the interior of buildings, depending on the circumstances, up to ⅔ of the total time required for a wall coating can be spent on the precise application of the paint edges alone. These include, for example, coating edges on an inner edge, outer edge, in an inner corner or outer corner, on a building feature in the application area or only as a colour design element. Time immemorial, this work step has been accomplished by first “masking off” with adhesive tape, i.e. by masking off the edges of the surface areas adjacent to a colour firing. Then the wall paint is first applied along the masking with small brushes, followed by the surface coating within the edges, usually with a paint roller. The conventional coating with the paint roller is always interrupted when paint is taken up from the paint pot by dipping the roller, excess paint has to be carefully removed again subsequently by using a grid and the paint roller is carefully guided back to the wall without dripping. This interruption, and not the rolling on the wall surface, determines a large part of the working time for this step.

Many of these problems are not only limited to the building sector, but also concern other areas, such as industrial coating technology (with paints), vehicle initial or repair coating.

From the prior art (e.g. “Anstr. 2011”, U.S. Ser. No. 14/386,334) a manually guided coating device for building walls is known, which includes a drop-on-demand head 2 (also called DOD head), as described for example in (“DK2009” U.S. Pat. No. 8,556,373). The coating device is suitable for applying single straight or curved strips of wall paint or other coating materials to an application surface. In practice, however, a large number of aspects play a role, so that, on the one hand, the necessary working methods are missing to coat the surface areas and edge areas mentioned at the beginning efficiently, accurately and cleanly.

On the other hand, the tasks require a specific design and mode of operation of the drop-on-demand applicators.

The invention is thus based on the task of creating an easily executable, time-efficient and clean working method for coating surfaces of components, in particular surfaces of the construction sector, including both the edge and the surface coating.

This task is solved by a method according to the invention and a first and/or second DOD applicator according to the invention, as well as corresponding DOD application systems.

The method according to the invention makes the time-consuming taping of the edge of a coating area 12, such as at an inner edge of a room, or the use of stencils, obsolete and, moreover, permits the precise and sharp-edged coating of a narrow (5 mm-5 cm, or 2 cm-10 cm, or 5 cm-20 cm) edge area at working speeds of up to 1 m/s without further preparatory work. At the same time, the method is compatible with the use of conventional application techniques such as rolling or spraying, which can still be used for large-scale coating work except for the edge areas of a coating area 12 or for small corrections or additions of any kind.

Furthermore, the method provides solutions for fast, convenient and at the same time clean application of coating agent at a high rate to an application surface 11 for coating the larger area regions inside the edges 12a of an application area 12, also using a DOD applicator.

In this way, in many cases, the labour time for a complete coating can be reduced to a fraction of the labour time required today, allowing painting services to be offered at a fraction of the price and attracting new customers who have previously done their own painting.

In the following, the invention is described and disclosed predominantly in the context of coating wall surfaces or other surfaces from the building sector. It should be noted that the method according to the invention and the associated DOD applicators are not limited with regard to the technical field of application and the type of component to be coated.

According to the invention, an application surface 11 of a component 10, in particular of a building within an application area 12, is coated with a coating agent, in particular with a building paint, the application comprising a step of edge application of the application area 12 and a step of surface application of the application area 12, which does not comprise the edge coating. In this case, the step of edge coating comprises the use of a first application method whose operating principle is based on the drop-on-demand method, and the step of surface coating comprises the use of a second application method, the second application method having a higher surface operating performance (in: sqm/min) than the first application method.

In this context, the application area 12 is understood to be the area of an application surface 11 of a component 10 that is to be coated with the coating agent. The application area 12 is bounded by the edges 12a of the application area 12. An edge application is understood to be that part of the coating process of an application area 12 which encloses the edge 12a of the application area 12 including an adjoining surface strip within the application area 12 of the single (or multiple) width of a DOD applicator used for this purpose, for example, i.e. a width of a few millimetres up to 10 cm-20 cm.

It should be noted that the order of the application steps is not determined. Nevertheless, it is advantageous to start with the edge application step.

The step of edge application comprises the application of one or more coating agent strips 20 with a width of 5-200 mm, preferably of 5-100 mm or particularly preferably of 5-50 mm, using a DOD applicator, which in connection with the edge application is referred to here as the first DOD applicator 1. A DOD (drop-on-demand) applicator is understood to be an application device whose operating principle is based on the drop-on-demand method. A coating agent strip 20 is formed from coating agent drops or jets 23 which emerge from drop-on-demand nozzles 3 located on the underside of the first DOD applicator 1 in the direction of the application surface 11 and are deposited on the application surface 11 as coating agent dots 19 which bond together with adjacent coating agent dots 19 to form a coating agent layer.

Along the edge 12a of an application area 12, a plurality of coating agent strips 20 are successively applied, which are connected to each other and each include an edge portion 12a of the coating agent area 12.

The edge application of a coating agent strip 20 is performed in such a way that the lateral edge 21 of the coating agent strip 20 coincides with an edge 12a of the application area 12 or has a positive or negative distance to the edge 12a in another desired manner. Basically, the first DOD applicator 1 is placed on the application area and moved in contact therewith along the edge 12a, hence the term application movement is used hereinafter. In the process, one or more coating agent drops or jets 23 are emitted at equidistant intervals from the nozzles 3 of the row of nozzles 4 onto the application surface 11, which are deposited on the application surface 11 as coating agent dots 19. Finally, adjacent coating agent dots 19 converge and bond to form a coherent layer.

The operation procedure of an edge application step depends in detail on,

i) whether the edge 12a of the application area 12 is an arbitrary line on the application area 12 is an arbitrary line on the application surface, and the edge application is to be carried out along this line freely and without further guides, or
ii) whether the edge 12a of the application area 12 coincides with an intersection curve 16 of the application area 12 with a further surface 13, as for example in the case of two neighbouring wall areas which are predominantly at an angle of 90° to each other in the construction area (FIG. 1), which thus represents the edge coating of an inner edge between two walls, or
iii) whether the edge application is carried out as in ii) starting from a third surface 14, which together with the application surface 11 and further surface 13 forms an inner corner, or
iv) whether a guide rail 17 is held on the application surface 11 at the location of the edge 12a of the application area 12, along which the edge application is carried out with the first DOD applicator 1 (FIG. 4), or
v) whether an edge application is to be precisely attached longitudinally or vertically to a previously applied coating agent strip 20a, or
vi) whether an edge application is to be accurately bonded longitudinally or vertically to a previously applied coating strip 20a, wherein the previously applied coating strip 20a has been applied from an inner corner of three surfaces as in case iii) and the edge application is performed along the second inner edge associated with an inner corner.

If the edge 12a of the application area 12 represents an arbitrary line on the application surface (case i) and the edge application is to be performed freely along this line without further guides, the application of a coating agent strip 20 for the edge application includes the following steps:

a) placing the first DOD applicator 1 on the application surface 11 at the location of an edge 12a of the application area 12,
b) thereby aligning the first DOD applicator 1 in such a way that the row 4 of nozzles 3 are directed perpendicularly to the edge 12a of a predefined or entirely arbitrary application area 12,
c) carrying out an application movement of the first DOD applicator 1 on the coating surface 11 with an acceleration phase and a deceleration phase along the edge 12a,
d) during the application movement, maintaining the contact of the first DOD applicator 1 with the application surface 11 and dispensing coating agent drops or jets 23 onto the application surface 11 through one or more nozzles 3
f) wherein the discharge of the coating agent drops or jets 23 takes place at equidistant distances A in the direction of movement 18, and
g) wherein the distances A are constant and independent of the speed of the first DOD applicator 1 on the application surface 11.

With this method, a high edge accuracy can already be achieved, especially if

a) the first DOD-applicator 1 is moved on wheels (5, 6) or narrow skids on the application surface 11, or
b) is moved slowly at speeds of <30 cm/s or <10 cm/s, or if frontal 34 or lateral 35 mechanical (e.g. pointers, gauges) or optical (e.g. a light beam) aids for edge detection are present or attached to the housing of the first applicator.

If the edge 12a of the application area 12 coincides with an intersection curve 16 of the application area with a further surface 13 (case ii), as for example in the case of two mutually perpendicular wall areas in the construction field (see FIG. 1), then the application of a coating agent strip 20 for the edge application comprises for example the following steps:

a) placing the first DOD applicator 1 on the application surface 11 in lateral contact with a further surface 13 which intersects the application surface 11 at an angle of 200-160°,
b) thereby aligning the first DOD applicator 1 in such way that the row 4 of nozzles 3 is aligned perpendicular to the intersection curve 16 of the two surfaces (11 and 13),
c) carrying out an application movement of the first DOD applicator 1 on the coating surface 11 at variable speed along the real or extrapolated intersection curve 16 of the two surfaces (11 and 13),
d) during the application movement, maintaining the contact of the first DOD applicator 1 with the application surface 11 and with the further surface 13 and discharging coating agent drops or jets 23 onto the application surface 11 through one or more nozzles 3,
f) wherein the discharge of the coating agent drops or jets 23 takes place at equidistant distances A in the direction of movement 18, and
g) wherein the distances A are constant and independent of the speed of the first DOD applicator 1 on the application surface 11.

In case iii), the edge application is basically carried out as in case ii), but starts from a third surface 14, which together with the application surface 11 and further surface 13 each encloses an angle of 20°-160° and forms an intersection curve 15a. This corresponds to the case of a corner coating, for example an interior corner 15. Here, the application of a coating agent strip starts from the corner. Compared to case ii, therefore:

a) in the step of placing the first DOD applicator 1, the front side 8 of the first DOD applicator 1 is additionally mechanically contacted with a third surface 14, and
b) starting from the third surface 14, the application movement according to case ii) is carried out along the intersection curve 16 of application surface 11 and the further surface 13.

Use of a stop rail 17 at the location of the edge 12a of the application area 12 is helpful when an edge application is to be performed at a high application speed, for example, from 20 cm/s to 1 m/s, and at the same time very accurately (case iv). the application of a coating agent strip 20 for the edge application includes, for example, the following steps:

a) aligning a guide rail 17 with an edge 12a of the application area 12 and fixing the guide rail with respect to the application area 11,
b) placing the first DOD applicator 1 on the application surface 11 in contact with the stop rail 17,
c) thereby orienting the first DOD applicator 1 so that the row 4 of nozzles 3 are directed perpendicularly to the edge 12a of the application area 12,
d) carrying out an application movement of the first DOD applicator 1 on the coating surface 11 along the guide rail, with an acceleration phase and a deceleration phase,
e) during the application movement, maintaining the contact of the first DOD applicator 1 with the application surface 11 and with the further surface 13 and discharging coating agent drops or jets 23 onto the application surface 11 through one or more nozzles 3,
f) wherein the discharge of the coating agent drops or jets 23 takes place at equidistant distances A in the direction of movement 18, and
g) wherein the distances A are constant and independent of the speed of the first DOD applicator 1 on the application surface 11.

A stop rail 17 may be, for example, a ruler or a 90° angle profile, have handles for ease of handling and have anti-slip provisions such as rubbers on the underside. For example, the guide rail 17 is pressed onto the application surface 11 with one hand, with a force of, for example, 5-50N, while the other hand is used to move the first DOD applicator along the guide rail 17 in contact with the application surface 11. Also, after alignment, the guide rail 17 can basically be fixed to other surfaces, such as trades, furniture or, if the edge 12a of the coating area 12 is an outer edge of a wall, e.g. to the outer edge of an associated second wall surface.

Further coating strips 20 can be attached to a lateral edge 21 or to a front 22 (or rear) edge of a previously applied coating strip 20a (FIG. 3), see case v). In detail, the individual steps are as follows:

a) placing the first DOD applicator 1 on the application surface 11 at an edge 12a of the application area 12 and at an edge (21, 22) of a previously applied coating agent strip 20,
b) thereby orienting the first DOD applicator 1 in such a way,
that the row 4 of nozzles 3 is aligned perpendicular to the edge 12a of the application area 12 and,
that the row 4 of nozzles 3 is aligned parallel to the lateral edge 21 or to the front or rear edge 22 of the previously applied coating agent strip 20a or to the free edge 12a of the application area 12, wherein the distance d3 of the first applied coating agent points 19 of the coating agent strip 20 to the edge (21, 22) of the previously applied coating agent strip 20 or to the free edge 12a of the application area 12 is so small that no gap occurs in the layer between the previously applied coating agent strip 20 and the coating agent strip 20 to be applied,
   c) carrying out an application movement of the first DOD applicator 1 on the coating surface 11 along the edge 12a of the application area 12 with an acceleration phase and a deceleration phase,
   f) wherein the discharge of the coating agent drops or jets 23 takes place at equidistant distances A in the direction of movement 18, and
   g) wherein the distances A are constant and independent of the speed of the first DOD applicator 1 on the application surface 11.

Finally, the coating process is to be described in detail for case vi), when an edge application is to be precisely joined to a previously applied coating strip 20a longitudinally or vertically, wherein the previously applied coating strip 20a has already been applied along a first inner edge starting from an inner corner of three surfaces, as in case iii), and the edge application is performed along the second inner edge associated with an inner corner. The coating sequence includes the following steps (FIG. 3): (a) placing the first DOD applicator 1 on the application surface 11 in lateral contact with a further surface 13 intersecting the application surface 11 at an angle of 80°-100°, and on an edge (21, 22), perpendicular to the further surface 13, of a coating medium web 20 previously applied to the application surface 11,

b) thereby orienting the first DOD applicator 1 in such a way,
that the row 4 of nozzles 3 is aligned perpendicular to the intersection curve 16 of the two surfaces (11 and 13), and so,
that the row 4 of nozzles 3 is aligned parallel to the edge (21, 22) of the previously applied coating agent strip 20, wherein the distance between the first applied coating agent points 19 of the coating agent strip 20 and the edge (21, 22) of the previously applied coating agent strip 20 is selected to be so small that there is no gap between the previously applied coating agent strip 20 and the coating agent strip 20 to be applied,
   c) carrying out an application movement of the first DOD applicator 1 on the coating surface 11 along the intersection curve 16 with an acceleration phase and a deceleration phase,
   d) during the application movement, dispensing of coating agent drops or jets 23 onto the application surface 11 through one or more nozzles 3,
   f) wherein the discharge of the coating agent drops or jets 23 takes place at equidistant distances A in the direction of movement 18, and
   g) wherein the distances A are constant and independent of the speed of the first DOD applicator 1 on the application surface 11.

If the variants of edge applications i) to vi) described above are transferred, for example, to a coating of wall surfaces in the building sector, for example with a wall paint, the following assignments are summarised once again here:

a) The application area 11 corresponds, for example, to the wall surface of a front wall to be coated. The application area 12 should thereby cover the entire wall surface.
b) The other surface 13 corresponds, for example, to a side wall area, a ceiling area or a floor area. The edges 12a of the application area 12 are defined by the inner edges of the front wall to be coated in relation to the side walls, the ceiling and the floor.
c) The third surface corresponds, for example, to a ceiling or a floor if the further surface is a side wall or corresponds to a side wall if the further surface is a ceiling surface or a floor surface. The above assignments are intended to allow the previously described detailed processes to be transferred from the general cases described to building surfaces.

It should be mentioned that immediately after the start of an application movement of the first DOD applicator 1, a first row of coating agent dots 19 is applied and the further rows of coating agent dots 19 are aligned with the first row.

With regard to the nozzles 3 of the first DOD applicator 1, it is advantageous if these are arranged in a nozzle row 4 within the first DOD applicator 1 in such a way that, when the first DOD applicator 1 is in contact with the application surface 11, the distance d1 (e.g. FIG. 7) between the intersection curve 16 of the application surface 11 with the further surface 13 or between the intersection curve (14a) of the application surface 11 with the further surface 14 and the nearest coating point 19 applied to the application surface 11 is smaller than a previously determined accuracy measure or than the nozzle spacing D.

With respect to the movement of the first DOD applicator 1, it is conceivable that the first DOD applicator moves at a small speed in the range between 0 cm/s and 10 cm/s, and is arbitrarily accelerated to higher speeds of, for example, 10 cm/s to 150 cm/s, and includes a braking phase in which the speed is decelerated down to 0 m/s.

After the application of one or more coating agent strips 20 by means of the first DOD applicator 1, there may be the problem that the edge of the coating agent strip 21 facing away from the edge 12a of the coating area 12 leaves a discernible line after the application area 12 has been completely coated in the step of surface application. In order to prevent this, various possibilities are proposed for coating agent strip 20 to be manually added, including that, after the coating agent strip has been applied, coating agent in the area of the edge 12a, namely at opposite edge 21, is to be manually added, distributed and/or leveled out using a brush, a cloth, a sponge or a roller.

Also, after application of one or more coating agent strips 20, it may be necessary to manually remove coating agent that has been inadvertently applied outside the edge 12a using a brush, cloth, sponge.

With regard to the movement of the first DOD applicator 1, various possibilities are suitable: Especially in the field of building coating, but also in the repair painting of vehicles, the first DOD applicator 1 is preferably moved manually with a handle 33. The handles shown in the figures are only symbolic. Any type of handle (including no handles) is conceivable. However, this does not exclude the embodiment of the first DOD applicator 1 as a programmed or autonomous mobile intelligent robot, which performs an edge detection of the edges of the coating area and, based on this, controls the movement and the delivery of the coating agent drops or jets 23. However, in the field of other industrial application technology (especially vehicles, in particular motor vehicles, in particular car body components), the automated and fully programmed movement by a Cartesian or articulated arm robot has advantages.

According to the invention, the delivery of the coating agent drops or jets 23 by the first DOD applicator 1 takes place at variable, even arbitrary, movement speed, whereby the distance A of the coating agent points on the application surface in the direction of movement always remains constant, irrespective of the movement speed of the first DOD applicator 1. This is achieved by the following process steps, which are characterised in,

a) that during the application movement, the distance travelled by the first DOD applicator 1 over the application surface 11 is measured and/or that the speed of the first DOD applicator 1 relative to the application surface 11 is continuously measured and that measurement data are formed therefrom,
b) that in a control unit 32, which is located within the first DOD applicator 1 or in a supply unit 31, the measurement data are processed further to form actuation signals for a drop-on-demand head (2, 2a, 2b) which contains the nozzles 3, the further processing being based on an algorithm which provides for firing of the nozzles 3 of the drop-on-demand head (2, 2a, 2b) at equidistant intervals A,
c) that the control data are transmitted to the drop-on-demand head (2, 2a, 2b), and
d) that one or more nozzles 3 are triggered for the delivery of coating agent drops or jets 23.

It should be mentioned that an edge application by means of the first DOD applicator 1 can be activated by pressing a button 55, which is located on the second DOD applicator 50 or on an associated supply device 31, and deactivated by releasing the button 55, or that an application process by means of the second DOD applicator (51) is activated by pressing and releasing a switch 55, which is located on the second DOD applicator 50 or on an associated supply device 31, and deactivated by pressing and releasing the switch 55 again. It should thereby be taken into account that, in accordance with the aforementioned algorithm, a coating agent supply basically only takes place in the event of measured movement on the application surface 11. The activation and deactivation of the first DOD applicator can take place, for example, by switching the coating agent pressure on and off and/or switching the power amplifiers for the coating agent valves 38 on and off and/or activating and deactivating the sensors for measuring the movement.

It should also be mentioned in particular that the edge application by means of the first DOD applicator 1 is carried out without prior masking of the edges 12a of the application area 12.

It should further be mentioned that the contacting of the first DOD applicator 1 with the application surface 11 can be carried out by means of wheels or rollers, and that their tread surfaces at the point of contact with the application surface 11 represent a lower reference surface (5, 6), which define the distance of the nozzles 3 from the application surface 11.

The first DOD applicator 1 may have further contact, sliding or reference surfaces (7, 8, 34, 35) which allow movement along surfaces, e.g. 11, 13, 14, edges, e.g. 16, 14a, 15a, or lines, e.g. 12a, such that there is a defined position of the nozzles 3 relative to the surfaces, edges and lines when the DOD applicator is in contact with the surfaces, edges and lines of components 10 via the reference surfaces. The housing 37 of the first DOD applicator 1 itself may implicitly have reference surfaces, such as the side surfaces which simultaneously act as reference surfaces and sliding surfaces 7 in contact with surfaces 13, 14 or 17, or the front housing surface 8 which is brought into contact, for example as described above, with surface 14 in order to apply a coating agent strip 20 starting from a corner 15. Sliding and reference surfaces (7, 8) can be machined out of the housing 37 itself and thus consist of the housing material (e.g. plastics such as PA, PEI, PP, PET, PC, POM, PVC, . . . ) or of abrasion-resistant inserts made of corresponding plastics or, for example, stainless steel.

Furthermore, a first DOD applicator 1 may comprise various aids (34, 35) predicting the front-side edge 22 and lateral edge 21 of a coating agent strip 20 to be applied. For example, front-side 34 or side 35 mechanical (e.g. pointers, gauges) or optical (e.g. a light beam, in particular a laser beam, in particular an expanded laser beam) aids can be mounted in such a way that they point to a predicted edge of a coating agent strip 20 to be applied. A pointer 35 on a side can be used to easily apply a coating agent strip 20 adjacent to an (arbitrary) line on the coating surface 11, by always pointing the pointer 35 towards the line during the application process. A front-side pointer 34, on the other hand, serves to precisely define the front edge of a coating agent strip 20 to be applied and to determine the starting point for the application of a coating agent strip 20. It is advantageous if the proposed aids 34 and 35 are additionally designed as reference surfaces and function as described above, see FIG. 6. Thus, the first DOD applicator 1 comprises optical and/or mechanical aids which point to the predicted lateral edges 21 and/or front-side edges 22 and/or corner points of a coating strip 20 to be applied and serve as a positioning basis for the start and/or the path course of an application movement of the first DOD applicator 1.

The present invention further provides for the step of a surface application of the application area 12, which does not include the edge application, using a second application method which has a higher surface application rate—in square meters of coated area per minute—than the first application method.

While the first DOD applicator 1 has the advantage that it has a high edge application rate (criterion for an edge coating: linear meters of edge per minute), its surface application rate is low due to the aforementioned small application width AB. It is therefore advantageous if the surface application is carried out with a further application method or with further applicators that have a high surface application rate.

On the one hand, the use of classic application methods is suitable, for example, by using paint rollers, brushes or paint sprayers.

On the other hand, a two-stage process can also be used, which comprises the use of a second DOD applicator 50, the operating principle of which is based on the drop-on-demand method. Considering a surface area of the application surface 12, the second application process comprises

a) a first step in which coating agent is applied to the coating area 12 by means of the second DOD applicator 50 without obtaining a closed and/or uniform layer. In this step, coating agent is “sprayed” at a high rate (in the order of milliliters to liters/minute) onto the coating area 12, whereby, unlike the other paint spraying techniques, the use of the DOD principle does not produce a coating agent mist.
b) In addition, the second application method comprises a second step in which the coating agent applied in the first step is distributed and/or leveled using a brush, cloth or painter's roller so that a gapless and/or uniform coating results (FIG. 1).

The second DOD applicator 50 is moved over the same section of the application surface 11 one or more times during application (FIG. 8),

a) by holding the second DOD applicator 50 in contact with the application surface 11, and/or
b) by moving the second DOD applicator 50 freely over the application surface 12 at a distance d₁₀ of 1 cm-500 cm, or 1 cm-150 cm in relation to the application surface 12 and with parallel 51 and/or rotating 52 and/or pivoting 53 movements, the movements preferably taking place in a (also curved) plane E (parallel to the image plane in FIG. 8) which is perpendicular to the row 4 of nozzles 3 of the second DOD applicator 50 and perpendicular to the application surface 12.

It should thereby be mentioned that an application process by means of the second DOD applicator 50 is started by pressing a button 55, which is located on the second DOD applicator 50 or on an associated supply device 31, and is stopped by releasing the button 55, or that an application process by means of the second DOD applicator (51) is started by pressing and releasing a switch 55, which is located on the second DOD applicator 50 or on an associated supply device 31, and is stopped by pressing and releasing the switch 55 again.

The drop-on-demand application of coating agent by means of the second DOD applicator 50 during an application process may be performed with a constant and/or adjustable and/or occasionally increasing and/or occasionally decreasing coating agent drop discharge frequency and/or with an arbitrarily programmed or programmable frequency profile, wherein the frequencies range from 0 Hz-5 kHz or 0 Hz-1.5 kHz or 0 Hz-500 Hz.

Furthermore, the drop-on-demand application of coating agent by means of the second DOD applicator 50 may be pulsed during an application process with constant and/or adjustable and/or occasionally increasing and/or occasionally decreasing and/or with an arbitrarily programmed or programmable opening time of the coating agent valve elements 38, wherein the pulse widths range from 0.2 ms-100 minutes, 0.7 ms-100 minutes or 2 ms-100 minutes. Very long opening times correspond to a pure jet application, which achieves the highest application rates, but also makes the process more difficult to control.

Further, the second DOD applicator 50 is configured such that the volume of the coating agent droplets or jets 23 applied to the application surface 11 is greater than the volume of the coating agent drops or jets 23 applied to the application surface 11 by the first DOD applicator 1.

While typical drop volumes of the first DOD applicator 1 in the case of wall paints are below 250 nanoliters to 1 microliter depending on the nozzle spacing D of the nozzles 3 and the spacing A of the coating agent dots 19, it is advantageous if the drop volumes of the second DOD applicator 50 are in the range from 500 nanoliters to 2 microliters or from 1 microliter to 10 microliters.

In the field of building coating, the process according to the invention can be widely used, for example, the application surface 11 and/or the further surface 13 and/or the third surface 14 can be internal or external surfaces on buildings, in particular of a) walls, b) ceilings, c) floors, d) building subassemblies, e) furniture, f) cladding, g) works of art, h) door or window frames, i) supporting structures or framework.

The discharge of the coating agent drops and/or jets 23 for coating applications in the field of construction are determined by a first set of influencing variables, which include a) that the nozzles 3 of the nozzle row 4 each have a diameter of 0.1 mm-1 mm or 0.2 mm-0.5 mm and/or b) that the nozzles have a distance to their neighboring nozzles of 0, 5 mm-5 mm or from 1 mm-3 mm, and/or c) that the distance of the nozzle outlets to the coating surface is 3 mm-50 mm or 5 mm-20 mm or 50 mm-300 mm and/or d) that the distances A between sequentially applied coating agent dots n 19 in the direction of movement 18 are in a fixed relation to the nozzle distance D and correspond to 0.2-5 times or 0.5 to 2 times or 1 times the nozzle distance D or 0, 5 mm-5 mm or 1 mm-3 mm and/or e) that the liquid overpressure to the environment present during a drop ejection from a nozzle 3 is 0.2 bar-20 bar or 0.5 bar to 10 bar or 1 bar to 5 bar and/or f) that a dispersion building paint is used as coating agent, which is configured for application by brush, roller or spraying device, wherein the paint is thinned by the addition of 2%-40% or 5%-20% or 5%-10% water and/or the rheology is modified by the addition of 0.01%-10% or 0.1-2% or 0.1-0.5% of a thickener acting predominantly in the shear rate range below 1000 1/s in such a way that the possible running-off of the paint on non-horizontal coating surfaces 11 as a result of the thinning is prevented.

Furthermore, the method according to the invention is suitable for applying coating agent drops and/or jets 23 in the field of painting or repair painting on surfaces of vehicles of any kind (motor vehicles, rail vehicles, aircraft, ships).

The discharge of coating agent drops or jets 23 by the first DOD applicator can in principle follow a decorative coating pattern. Thus, instead of a continuous closed layer, for example in the case of edge application, the DOD technology implicitly opens up the possibility of applying a continuous or repetitive pattern or lettering to an edge 12a of an application area 12 or to any other location of a surface in the context of the present invention using the first DOD-applicator 1.

Essential for a reliable operation of the method according to the invention is also a conditioning and cleaning of the nozzles 3 of the first DOD applicator 1 and the second DOD applicator 50. This comprises a number of measures, for example

a) that in recurring sequence the nozzles 3 of the nozzle row 4 are wiped with a cloth, tissue or sponge, and/or
b) that the nozzles 3 of the nozzle row 4 are repeatedly wiped with a cloth, tissue or sponge soaked with water, a solvent or a drying retarding agent such as glycol or glycerine, and/or
c) that in case of an interruption of the application, a cover is applied to the nozzles 3, which closes them and thus prevents the drying of the coating material in the nozzles 3, and/or
d) in that, when application is interrupted, a cover is applied to the nozzles 3 which contains a sponge impregnated with water, with solvent or with a drying-retarding agent such as glycol or glycerine, preferably in a closed environment, and/or
e) that during an interruption of the application the nozzles 3 are flushed with water or a solvent, and/or
f) that during an interruption of the application the part of the applicator (1, 50) containing the nozzles 3 is removed and cleaned or disposed of externally.

### LIST OF FIGURES

FIG. 1 shows aspects of the application method according to the invention in connection with DOD applicators according to the invention.

FIG. 2 shows the application of a first DOD applicator 1 to a corner of a room 15 for the application of a coating agent strip 20, as the first strip of a corner coating.

FIG. 3 shows the application of a first DOD applicator 1 for coating a corner 15 of a room to a previously applied coating agent strip 20a for continuing the corner coating on an edge (14a) of a third surface 14.

FIG. 4 shows the application of a coating agent strip 20 along a stop rail 17.

FIG. 5 shows a side view of essential components of a first DOD applicator 1.

FIG. 6 shows a first DOD applicator 1 at the edge 12a of an application area 12 with various auxiliary means (34, 35) and reference surfaces (7, 8) that predict the frontal and lateral edges of a coating agent strip 20 and facilitate the movement of the applicator along lines or surfaces.

FIG. 7 shows a first DOD applicator 1 with rollers (5, 6) in the case of coating corners with an uncomfortable sharp angle in two different ways.

FIG. 8 shows a surface application using a) a second DOD applicator in a first step and b) a paint roller for levelling the applied coating agent in a second step.

FIG. 9 shows a side view of essential components of a second DOD applicator 50. The reference labels correspond to those of the first DOD applicator 1, but it is pointed out that many of the components can be designed or constructed differently.

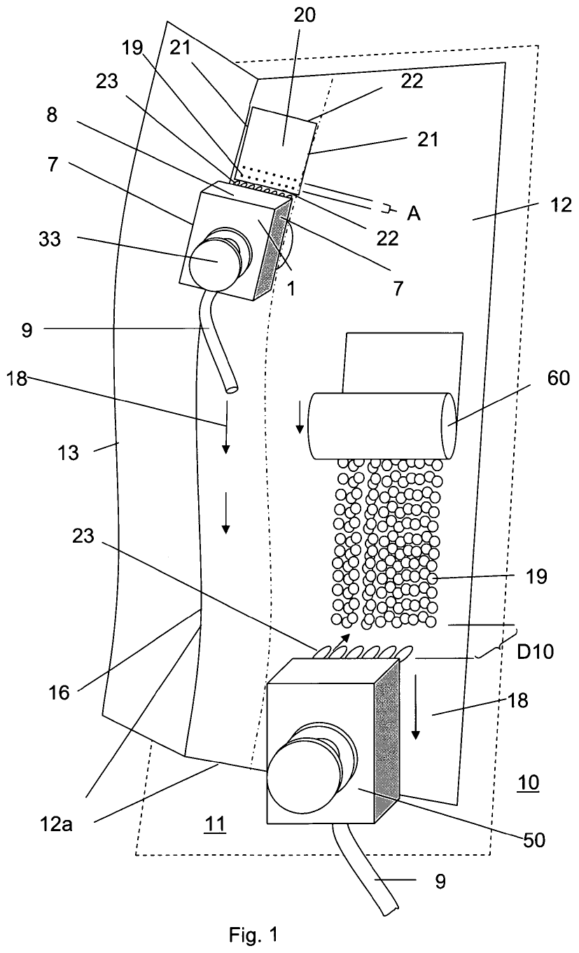

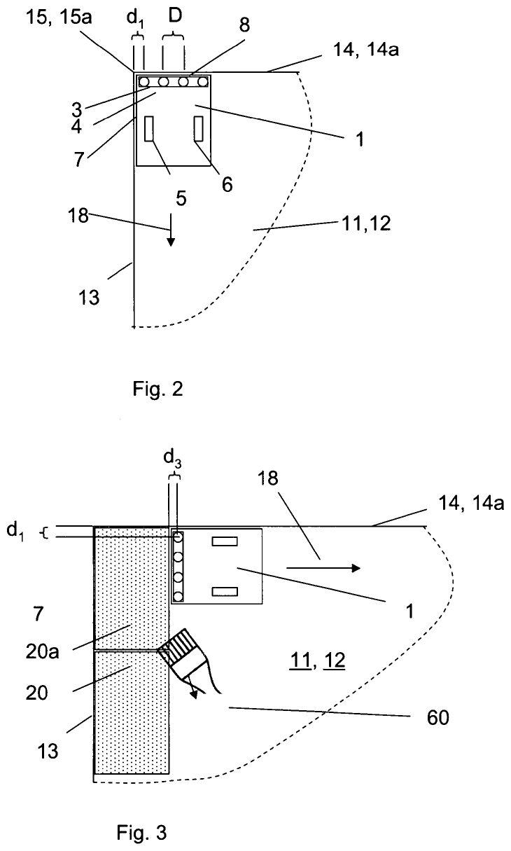

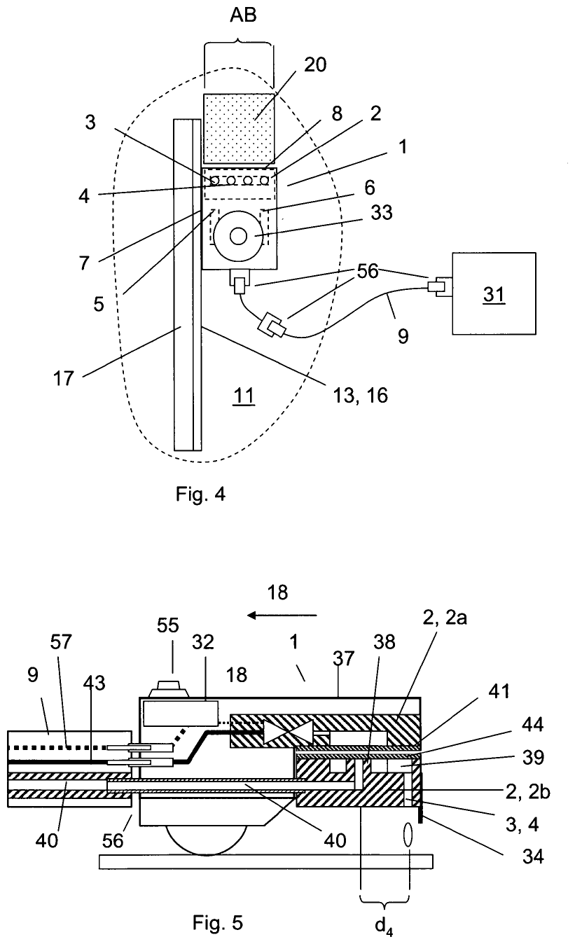

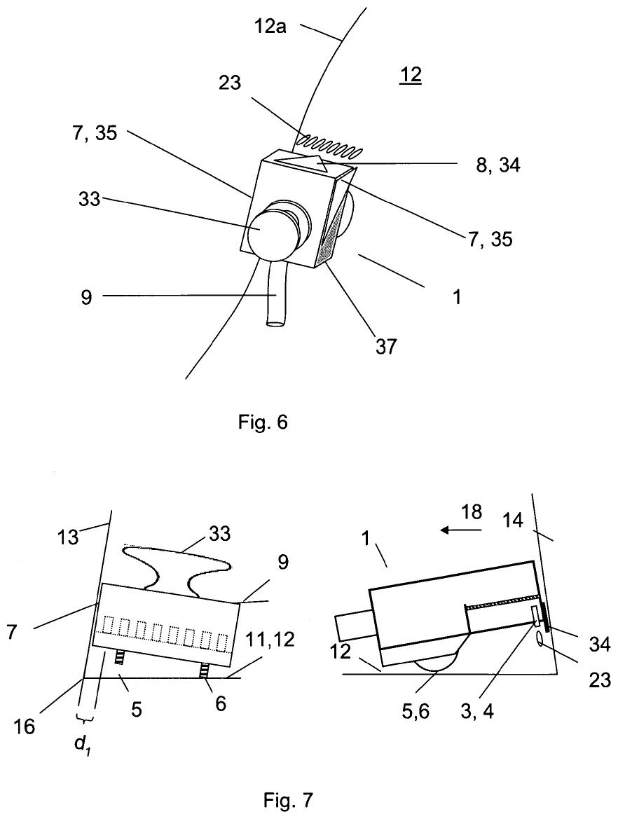

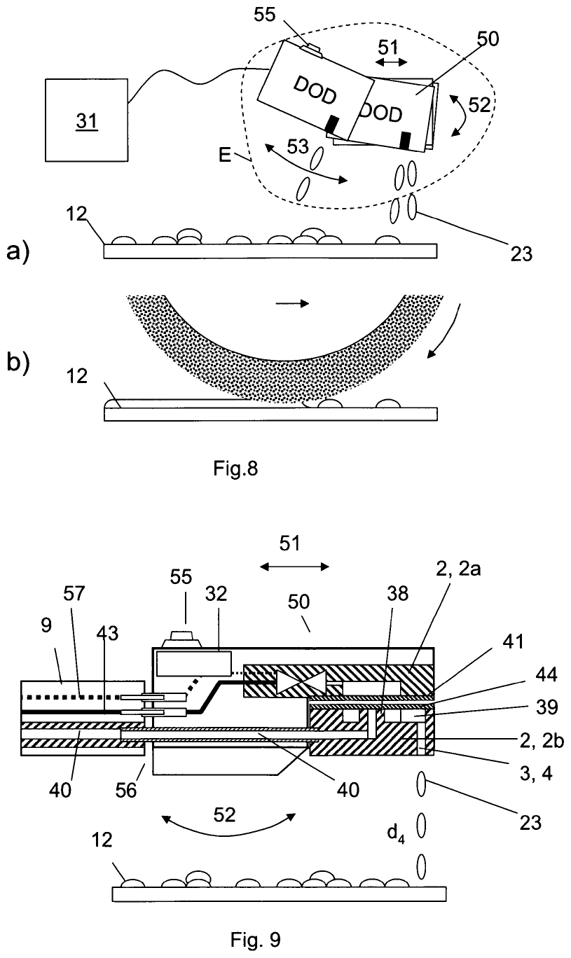

In the following, the composition of the components of the first DOD applicator 1 and the second DOD applicator 2 is illustrated with reference to the figures. Thereby a) a first DOD applicator 1 with a first drop-on-demand head 2, which is provided for the discharge of coating agent drops or jets 23, and b) a supply unit, which supplies the first DOD applicator 1 fluidically and electrically, and c) one or more supply lines 9, designed for the connection of DOD applicators with supply units 31 represent essential basic components of a DOD application system for coating an application surface 11 of a component 10, in particular a building within an application area 12, with a coating agent.

The application system may have one or more of these basic components respectively.

For example, different first DOD applicators 1 can be part of a modular system, which are used within the application system, with different configurations and designs, for example with regard to the following features: (a) application width AB, (b) viscosity range of compatible coating agents, (c) droplet size range, (d) nozzle diameters and distances D, (e) materials and designs of the liquid-carrying parts, (f) heatability, (g) exit angle of the coating agent drops or jets 23, (h) design as front shooter (not shown, droplet exit at front side 8) or bottom shooter (as shown in FIG. 5), i) type of path or speed measurement.

For example, different versions of supply units 31 can be part of the application system alternatively or in a complementary manner, sorted here according to different criteria. According to the type of supply unit: a) supply unit 31 as a stand-alone device, b) as a device that can be worn on the body, for example on the hip or as a backpack. The supply unit can also be divided into two parts: a stand-alone unit with a larger ink tank+intermediate storage and control unit on the body, ink filtering close to the applicator.

According to the type of coating agent supply to the supply unit: a) pressurised coating agent tank; b) coating agent pump with suction line to external coating agent bucket, c) recirculation supply.
According to the area of application: a) Variants for large construction sites and coating areas, b) Variants for use in confined spaces.
By industry: a) variants for the construction industry, b) for shipbuilding, aircraft construction, automotive construction, c) for refinishing, etc.

Furthermore, various supply lines 9 can be part of the DOD application system, which have couplings 56 to the individual DOD applicators 1 or 50 and supply units 31.

Another DOD application system, especially designed for surface application according to the method of the invention, comprises a) a second DOD applicator 50 with a second drop-on-demand head 2, which is intended for the discharge of coating agent drops or jets 23, and b) a supply unit, which supplies the second DOD applicator 1 fluidically and electrically, and c) one or more supply lines 9, designed for the connection of DOD applicators with supply units 31.

It is advantageous if a drop-on-demand application system enables both a drop-on-demand edge application and a drop-on-demand surface application. Thus, a DOD application system according to the invention comprises

a) at least one first DOD applicator 1 for carrying out an edge application of the application area 12, with a first drop-on-demand head 2, which is provided for the discharge of coating agent drops or jets 23,
b) a supply unit which supplies the first DOD applicator 1 fluidically and electrically,
c) one or more supply lines 9, designed for the connection of DOD applicators with supply units 31 and additionally
d) at least one second DOD applicator 50 for carrying out a edge application of the application area 12, with a second drop-on-demand head 50, which is provided for the discharge of coating agent drops or jets 23.

The design of the first and second drop-on-demand head 2 can in principle be of any type for carrying out the method according to the invention, as long as coating agent drops or jets can be discharged in a suitable way. Preferably, a suitable drop-on-demand head 2 consists of two parts, a) a liquid-carrying part 2b comprising one or more mechanically or pneumatically actuated coating agent valve elements 38 and a row 4 of nozzles, and b) a control part (2a) for controlling the liquid-carrying part 2b. The connection of the liquid-carrying part 2b to the control part (2a) is advantageously made by means of a quick-release connection, so that a quick change of the liquid-carrying part 2b is possible within 5 seconds to 15 minutes.

The aforementioned fluid-carrying part 2b contains, for example, one or more coating agent valve elements 38 which are operated by mechanical actuating forces or which are operated by pneumatic control pressures acting on valve diaphragms 44. The coating agent valve elements 38 are connected on the outlet side to one or more nozzles 3 and on the inlet side to a coating agent supply line 40 through which coating agent is supplied under pressure. The individual coating agent valve elements 38 contain, for example, a fixed valve seat and a movable closing element corresponding to the sealing element.

The aforementioned coating agent valve elements 38 contain, for example, one or more fluid connections 39 on the outlet side consisting of fluid channels and/or cavities which are connected to the one or more nozzles 3. Furthermore, it is advantageous if the one or more coating agent valve elements 38 are set back from the row 4 of nozzles 3 by a distance d₄ of 0 mm-20 mm. In this way, the row 4 of nozzles 3 can be placed close to the leading edge. The length of the fluid connections is typically from 0.1 mm-10 mm, and the cross-sectional dimensions are 0.2 mm-2 mm.

The control parts contain, for example, one or more electro-mechanical actuators (piezo, coil) which, via actuating elements performing actuating movements, respectively actuate one or more coating agent valve elements 38 of the liquid-carrying part 2b, or one or more pneumatic valves 42, preferably micro-pneumatic valves, which are connected to a compressed air supply 43 and generate the control pressures for respectively actuating one or more pneumatically operated coating agent valve elements 38 of the liquid-carrying part 2b.

It is advantageous if between the control part (2a) and the fluid-carrying part 2b there is an elastic sealing membrane 41 which is connected to the control part (2a) and which is designed in such a way that it can transmit the mechanical actuating movements of the mechanical actuators to the corresponding one or more mechanically actuated coating agent valve elements 38 of the fluid-carrying part 2b, that it can transmit the mechanical actuating movements of the mechanical actuators to the corresponding one or more mechanically actuated coating agent valve elements 38 of the liquid-carrying part 2b and/or which is designed in such a way that it can transmit the pneumatic control pressures to the valve diaphragms 44 of the one or more pneumatically actuated coating agent valve elements 38.

With regard to the first DOD applicator 1, it is advantageous if the width of the first drop-on-demand head (2, 2a, 2b) is greater than the application width (AB) by at most 2 nozzle spacings (D), and/or if the width of the first DOD applicator 1 is greater than the application width (AB) by at most 2 nozzle spacings (D). For the area of edge application in the interior of buildings, it is advantageous if the first DOD applicator 1 has an application width (AB) of 5 mm-50 mm or 5 mm-150 mm.

Furthermore, it is advantageous, particularly for the first DOD applicator 1,

a) if the nozzles 3 are arranged equidistantly within the nozzle row 4, and/or
b) if the distance D between the nozzles 3 is 0.5-5 mm, and/or
c) if the nozzles 3 are parallel and directed towards the application surface 11, and/or
d) when the nozzle row 4 extends to the width of the first DOD applicator 1, the distance of the edge nozzles of the nozzle row 4 from the respective side surface 7 of the first DOD applicator 1 being 0.5 times to 2 times the nozzle distance D,
f) if the diameter of the nozzles is from 0.05 mm to 1 mm and/or
g) when the nozzle row 4 is located inside the first DOD applicator 1 at the front side 8 of the first DOD applicator 1, wherein the distance of the nozzle row 4 to the front side 8 of the first DOD applicator 1 is from 0.5 times to 2 times the nozzle distance D.

To enable clean drop tear-off at the nozzles 3, it is advantageous if the coating agent valve elements 38 of the first drop-on-demand head and second drop-on-demand head are configured to be able to perform switching times of 0.1 ms-5 ms or 0.1 ms-2 ms or 0.1 ms to 0.5 ms.

With regard to the materials of the liquid-carrying part 2b of the DOD head of the first DOD applicator 1 or second DOD applicator 50, it should be noted that these must be inert to the coating agent. In the case of water-based wall paints or basecoats, the following materials are suitable, for example: POM, PA, PC, PS, PP, PE, PMMA, PEEK, PVDF, PEEK, PET, PMMA, TPFE, PFA, stainless steel, nickel, aluminium.

Furthermore, it is advantageous for the liquid-carrying part 2b of the DOD head 2, but also of the housing 17 of the first DOD applicator 1 or second DOD applicator 50, if these exhibit a contact angle of >450 or >1200 in combination with the coating agent (wall paint, building paints, water-based paints and other paints in the automotive sector). This can be favoured on the one hand by a suitable choice of material or also by suitable surface treatments such as the hydrophobisation of the surfaces, for example by sol-gel methods.

In practice, DOD applicators must be highly robust—also with regard to dirt and moisture. In particular, it should be possible to clean the entire DOD applicator under running water or in an ultrasonic basin. This requires that the at least one first DOD applicator 1 and/or the at least one second DOD applicator 50 is designed to be dust and water protected according to one of the protection classes IP65 to IP69. In particular, attention should also be paid to complete tightness and sealing of the sealing membrane 41 towards the control part.

Finally, it should be noted that if the first DOD applicator 1 is designed accordingly, it can also be used instead of the second DOD applicator for the purpose of surface application according to the method described above,

a) in that the first DOD applicator 1 and the second DOD applicator 50 are identical or of the same design or the first applicator is operated in the same way as a second applicator 50 in the surface application step, and/or
b) in that the first DOD applicator 1 is operated like a second DOD applicator 50, so that the coating agent application in the surface application step takes place at a higher coating rate than in the edge coating step, in particular at a 1-2, 1-5 or 1-10 times the coating rate, and/or
c) in that the first DOD applicator 1 is operated like a second DOD applicator 50, wherein the first DOD applicator 1 is operated for this purpose with a liquid-carrying part 2b which differs from that used for edge application and which has a higher coating agent output than the liquid-carrying part 2b of the first DOD applicator 1. This can be achieved by
i) a larger number of nozzle rows 4, and/or
ii) a larger number of nozzles 3 per nozzle row 4, and/or
iii) longer actuation times of the coating agent valve elements 38, and/or
iv) applying a higher fluid pressure, and/or
v) using wider nozzle rows 4, and/or
vi) using coating agent valve elements 38 with a higher total fluid throughput.

The invention is not limited to the embodiments described above. The invention also claims protection for the subject-matter and features of sub-claims independently of the respective references back to the aforementioned claims or even the main or side claim.

### LIST OF REFERENCE LABELS

1 First DOD applicator
2 Drop-on-demand head
2a Control part of the drop-on-demand head
2b Replaceable liquid-carrying part of the drop-on-demand head
3 Nozzle
4 Nozzle row
5,6 Reference surfaces on the underside, here as wheels
7 Side of the applicator, lateral sliding and reference surface
8 Front side, front reference surface
9 Supply line to a supply unit with electrical control signals and/or sensor signals, coating
agent supply, rinsing agent supply
10 Component to be coated
11 Application area, wall area
12 Application area (can also be selected spontaneously)
12a Paint edge of the application area
13 additional surface, side wall surface
14 third surface, front wall surface
14a Inner edge (intersection curve) of application area 11 and front wall area 14
15 Room corner
15a Inner edge (intersection curve) of lateral wall surface 13 and third, or front wall surface
14
16 actual or extrapolated intersection curve of application surface 11 and further 13, or lateral wall surface
17 (temporary) guide rail, auxiliary tool
18 Direction of movement
19 Coating centre point, has a diameter, the position of the coating point always refers to the centre of the point
20 Coating agent strip
21 Lateral edge of the coating agent strip
22 Front edge of the coating agent strip
23 Coating agent drop or jets
30 Sensors for measuring the movement of the applicator in relation to the application surface.
31 Supply unit with coating agent container, pumps or compressor, control system
32 Electronic control
33 Attachment or handle/knob
34 Mechanical (e.g. pointers, gauges) or optical (e.g. a light beam) aids for edge detection, front side
35 Mechanical (e.g. pointers, gauges) or optical (e.g. a light beam) aids for edge detection, lateral
36 Control unit
37 Applicator housing
38 Coating agent valve elements
39 Fluid line or cavity to nozzles
40 Coating agent supply line
41 Sealing diaphragm
42 Pneumatic valve
43 Compressed air supply
44 Valve diaphragm
50 Second DOD applicator
51 Parallel movements of the second DOD applicator
52 Rotating movements of the second DOD applicator
53 Swivelling movements of the second DOD applicator
55 Button, switch
56 coupling
57 Electrical connections
60 Paint roller or brush
D Nozzle spacing
d₁ lateral distance between first/last nozzle of a row and an edge 12a of the application area 12
d₃ frontal distance of a nozzle 3 from the nozzle row 4 to a frontal edge of a coating sheet or an existing coating strip
d₄ back offset of the coating agent valve elements 38 behind the vertical plane of the nozzle outlets
d₁₀ Application distance second DOD applicator
A Distance between adjacent nozzles 3
AB Application width of a DOD head/DOD applicator
E Plane perpendicular to the row of nozzles 4 and to the application surface 11

1. A coating method, comprising
an edge application step, wherein a coating agent, in particular a wall paint, is applied to a wall (11) of a building within an application area (12) by using a first application method, which works according to a drop-on-demand application method, the edge application step comprising successive application of one or more coating agent strips (20), each of which include an edge portion (12a) of the application area (12), and
a surface application step, wherein a portion of the application area (12) is coated, which does not include the edges (12a), by using a second application method,
wherein the second application method has a higher surface coating rate than the first application method.

2. Method according to claim 1, characterized in,
a) that in the step of edge application, the one or more coating agent strips (20) are applied by means of a first drop-on-demand applicator (1) having an application width of 5-200 mm, or preferably 5-100 mm,
b) that the coating agent strip (20) is applied in such a way, that the lateral edge (21) of the coating agent strip (20) comes to coincide with an edge (12a) of the application area (12),
c) that the coating agent strip (20) is formed of coating agent drops or jets (23) which are discharged onto the wall (11) from drop-on-demand nozzles (3) located on the underside of the first drop-on-demand applicator (1),
d) that the coating agent drops or jets (23) are deposited on the wall (11) as coating agent dots (19), and
e) that adjacent coating agent dots (19) bond together to form a coherent layer.

3. Method according to claim 2, characterized in, that the application of a coating agent strip (20) for edge application comprises the following steps:
a) placing the first DOD applicator (1) on the wall (11) at the location of an edge (12A) of the application area (12),
b) thereby aligning the first DOD applicator (1) in such way, that the row (4) of nozzles (3) are directed perpendicularly to the edge (12a) of a predetermined or overall arbitrary application area (12),
c) carrying out an application movement of the first DOD applicator (1) on the coating surface (11) along the edge (12a) with an acceleration phase and a deceleration phase,
d) during the application movement, maintaining the contact of the first DOD applicator (1) with the wall (11) and discharging coating agent drops or jets (23) onto the wall (11) through one or more nozzles (3),
f) wherein the discharge of the coating agent drops or jets (23) takes place at equidistant distances A in the direction of movement (18), and
g) wherein the distances A are constant and independent of the speed of the first DOD applicator (1) on the wall (11).

4. Method according to claim 3, characterized in,
a) that the edge (12a) of the application area (12) corresponds to the intersection curve (16) of the application area (12) with a further surface (13) and, in order to carry out the edge coating, the first DOD applicator (1) is moved along the further surface (13) in contact therewith, or
b) that the edge (12a) of the application area (12) corresponds to the intersection curve (16) of the wall (11) with a guide rail (17) and the first DOD applicator (1) is moved along the guide rail (17) in contact therewith in order to carry out the edge coating, or
c) that the placement of the first DOD applicator (1) additionally includes the alignment of the front side (8) of the first DOD applicator (1) with a third surface (14), with the edge (21, 22) of a previously applied coating agent strip (20) or with a free edge (12a) of the coating area.

5. Method according to claim 1, characterized in that an edge application of a wall (11) in an inner corner (15) of a room in a building is carried out, wherein
a) the further surface (13) corresponds to the area of a side wall, a ceiling or a floor, and
b) the application area (12) on the wall surface is delimited by edges (12) corresponding to the inner edges between the wall (11) and the side wall, the wall (11) and the ceiling or the wall (11) and the floor.

6. Method according to claim 2, characterized in that after or during the application of a coating agent strip (20)
a) coating agent in the region of the edge (21) of the coating agent strip (20), which is facing away from the edge (12a), is distributed manually over said edge (21) by using a brush, a cloth, a sponge or a roller, and/or
b) coating agent is manually added, distributed or levelled at the edge (12a) of the application area (12) with a brush, cloth, sponge or roller, and/or
c) coating agent which has been applied unintentionally beyond the edge (12a) is removed manually with a brush, a cloth, or sponge.

7. Method according to claim 1, characterized in
a) that, during the application movement, the distance covered by the first DOD applicator (1) over the wall (11) is measured and/or that the speed of the first DOD applicator (1) relative to the wall (11) is continuously measured and that measurement data are formed therefrom,
b) that in a control unit (32), which is located within the first Drop-on-Demand applicator (1) or in a supply unit (31), the measurement data are converted into control signals for controlling a Drop-on-Demand head (2, 2a, 2b), the conversion being based on an algorithm which provides for firing of the nozzles (3) of the drop-on-demand head (2, 2a, 2b) at equidistant intervals (A),
c) that the control signals are being transmitted to the drop-on-demand head (2, 2a, 2b), and
d) that one or more nozzles (3) are being triggered for the discharge of coating agent drops or jets (23).

8. Method according to claim 1, characterized in that the edge application is carried out by means of a first Drop-on-Demand applicator (1) without prior masking and/or masking of the edges (12a) of the application area (12).

9. Method according to claim 1, characterized in that the second application method comprises the use of a paint roller, a brush or a paint spraying device.

10. Method according to claim 1, characterized in that the second application method comprises the use of a second DOD applicator (50) whose operating principle is based on the drop-on-demand method, the second application method comprising
a) a first step of surface application, in which the application of coating agent to the coating area (12) is carried out by means of the second DOD applicator (50) without obtaining a closed and/or uniform layer, and
b) a second surface application step in which the coating agent applied in the first step is spread and/or leveled using a brush, cloth or paint roller.

11. Method according to claim 10, characterized in that in the first step of the surface application the second DOD applicator (50) is moved one or more times over a section of the wall (12) at a distance of 1 cm-500 cm, or 1 cm-150 cm in parallel (51) and/or rotating (52) and/or pivoting (53) movements, wherein on actuation of a key or a switch the DOD coating agent application takes place with constant or variable drop frequency and/or constant or variable drop size.

12. Method according to claim 1, characterized in, that the discharge of the coating agent drops and/or jets (23) are determined by a first set of influencing variables, which include,
a) that the nozzles (3) of the nozzle row (4) each have a diameter of 0.1 mm-1 mm or 0.2 mm-0.5 mm and/or
b) that the nozzles have a distance to their neighboring nozzles of 0.5 mm-5 mm or of 1 mm-3 mm, and/or
c) that the distance of the nozzle outlets to the coating surface is 3 mm-50 mm or 5 mm-20 mm or 50 mm-300 mm and/or
d) that the distances A between coating agent dots (19) applied sequentially in the direction of movement (18) are in a fixed relationship to the nozzle distance D and correspond to 0.2-5 times or 0.5-2 times or 1 time the nozzle distance D or are 0.5 mm-5 mm or 1 mm-3 mm and/or
e) that the liquid overpressure in relation to the environment during a drop ejection from a nozzle (3) is 0.2 bar-20 bar or 0.5 bar to 10 bar or 1 bar to 5 bar and/or
f) that as coating agent a building dispersion paint is used which is configured for application by brush, roller or spraying device, wherein the paint is diluted by addition of 2%-40% or 5%-20% or 5%-10% water and/or, by addition of 0.01%-10% or −0.1-2% or 0.1-0.5% of a thickening agent acting predominantly in the shear rate range below 1000 1/s, the rheology is modified in such a way that the possible run-off of the paint on non-horizontal coating surfaces (11) as a result of the dilution is prevented.

13. Method according to claim 12, characterized in
a) that the nozzles (3) of the nozzle row (4) are cleaned with a cloth, tissue or sponge in recurring sequence, and/or
b) that the nozzles (3) of the nozzle row (4) are wiped in recurring sequence with a cloth, tissue or sponge soaked with water, a solvent or a drying retarding agent such as glycol or glycerine, and/or
c) that in case of an interruption of the application, a cover is applied to the nozzles (3) which closes them and thus prevents the drying of the coating material in the nozzles (3), and/or
d) that, when application is interrupted, a cover is applied to the nozzles (3), which cover contains a sponge impregnated with water, with solvent or with a drying-retarding agent such as glycol or glycerine, preferably in a closed environment, and/or
e) that during an interruption of the application the nozzles (3) are flushed with water or a solvent, and/or
f) that during an interruption of the application the part of the applicator (1, 50) containing the nozzles (3) is removed and cleaned or disposed of externally.

14. A DOD application system for coating a wall (11) of, a building within an application area (12) with a coating agent according to claim 1, comprising
a) a first DOD applicator (1) for carrying out an edge application of the application area (12), having a first drop-on-demand head (2) which is provided for the discharge of coating agent drops or jets (23), and
b) a supply unit which supplies the first DOD applicator (1) with fluid and electrical power, and
c) one or more supply lines (9) designed for connecting DOD applicators to supply units (31).

15. A DOD application system according to claim 14, comprising
b) a second DOD applicator (50) for applying coating agent to the application area (12) for performing surface coating of the application area (12) excluding edge application, having a second drop-on-demand head (2) provided for the discharge of coating agent drops or jets (23).

16. A DOD application system according to claim 15, characterized in,
a) that the first and/or second drop-on-demand head (2) comprises a liquid-carrying part (2b) with one or more mechanically or pneumatically actuated coating agent valve elements (38) and a row (4) of nozzles, and
b) that the first and/or second drop-on-demand head (2) comprises a control part (2a) for controlling the liquid-carrying part (2b), and
c) that the liquid-carrying part (2b) is connected to the control part with a quick-release connection and a change of the liquid-carrying part (2b) takes place in 5 seconds to 15 minutes.

17. A DOD application system according to claim 16, characterized in,
a) that between the control part (2a) and the fluid-carrying part (2b) there is an elastic sealing membrane (41) connected to the control part (2a) and formed in such a way
b) that it can transmit the mechanical actuating movements of the mechanical actuators to the corresponding one or more mechanically actuated coating agent valve elements (38) of the liquid-carrying part (2b) and/or
c) that it can transmit the pneumatic control pressures to the valve diaphragms (44) of the one or more pneumatically operated coating agent valve elements (38)
d) and that it ensures, together with the housing (37), protection against dust and moisture in accordance with one of the protection classes IP65 to IP 69.

18. DOD application system according to claim 14, characterized in,
a) that the nozzles (3) of the first DOD applicator (1) are arranged equidistantly within the row of nozzles (4) and the distance D between the nozzles (3) is 0.5-5 mm and the diameter of the nozzles is from 0.05 mm to 1 mm,
b) that the nozzles (3) of the first DOD applicator (1) are parallel and directed towards the wall (11),
c) that the row of nozzles (4) of the first DOD applicator (1) extends to the width of the first DOD applicator (1), the distance of the edge nozzles of the row of nozzles (4) from the respective side surface (7) of the first DOD applicator (1) being 0.5 times to 2 times the nozzle distance D, and
d) that the nozzle row (4) is located inside the first DOD applicator (1) at the front side (8) of the first DOD applicator (1), wherein the distance of the nozzle row (4) from the front side (8) of the first DOD applicator (1) equals 0.5 to 2 times the nozzle distance D.

19. A DOD application system according to claim 15, characterized in,
a) that the first (1) and second DOD applicator (50) are identical, and/or
b) that the first (1) and the second DOD applicator (50) are identical and the second DOD applicator (50) is operated in such a way that the step of surface coating takes place at a higher coating rate than the step of edge coating, in particular with a coating rate of 1-2, 1-5 or 1-10 times, and/or
c) in that the second DOD applicator (50) is operated with a liquid-carrying part (2b) which enables a higher coating performance than the liquid-carrying part (2b) of the first DOD applicator (1), by a larger number of nozzle rows (4) and/or of nozzles (3) per nozzle row (4) and/or by using longer actuation times and/or by applying a higher fluid pressure, and/or by using wider nozzle rows (4) and/or by using coating agent valve elements (38) with a higher fluid throughput in total.
